(19) United States
(12) Patent Application Publication
(10) Pub. No.: US 2026/0196902 A1
(43) Pub. Date: Jul. 9, 2026

(54) ELECTRIC MOTOR AND GASKET

(71) Applicant: FANUC CORPORATION, Yamanashi (JP)

(72) Inventor: Jun FUJIMOTO, Yamanashi (JP)

(21) Appl. No.: 19/128,149

(22) PCT Filed: Dec. 12, 2022
(86) PCT No.: PCT/JP2022/045681

§ 371 Date: May 7, 2025

(51) Int. Cl. H02K 5/10; F16J 15/06; F16J 15/08

(52) U.S. Cl. CPC H02K 5/10; F16J 15/062; F16J 15/0818; F16J 2015/0856

(57) ABSTRACT

This electric motor comprises: a first member having a recess forming surface in which a recess is formed; a gasket which has a bead and which is disposed so that the bead contacts a section of the recess forming surface other than the recess; and a second member that, along with a first member, sandwiches the gasket.

### RELATED APPLICATIONS

The present application is a National Phase of International Application No. PCT/JP2022/045681 filed Dec. 12, 2022.

### TECHNICAL FIELD

This disclosure relates generally to an electric motor and a gasket.

### BACKGROUND ART

Electric motors may be used in hostile environments. For example, an electric motor for a machine tool is used in an environment where cutting fluid splashes. The splashing cutting fluid may get inside the electric motor that causes a malfunction. Thus, gaskets are provided between members which constitute the electric motor (see, e.g., Patent Literature 1).

### PRIOR ART DOCUMENT

### Patent Literature

[Patent Literature 1]Japanese Patent Laid-Open Publication No. 2015-25513

### BRIEF DESCRIPTION OF THE DRAWINGS

FIG. 1 is a front view of an example of an electric motor;

FIG. 2 is a plane view of an example of a gasket;

FIG. 3 is an enlarged view showing a part of FIG. 2;

FIG. 4 is an aligned section view IV-IV in FIG. 3;

FIG. 5 illustrates an example of placement of a recess and beads;

FIG. 6 shows a comparative example;

FIG. 7 illustrates another example of the placement of the recess and the beads;

FIG. 8 shows a comparative example;

FIG. 9 illustrates an electric motor of a second embodiment;

FIG. 10 shows a comparative example;

FIG. 11 shows another example of the gasket;

FIG. 12 shows yet another example of the gasket; and

FIG. 13 shows an example of fixation of a first member and a fourth member.

### DETAILED DESCRIPTION

In conventional arts, if there is a recess between the surfaces of the members sandwiching a gasket, a gap may be created between the members. In this case, a foreign matter, such as cutting fluid, gets inside the electric motor and causes a malfunction in the electric motor. Thus, there is a need for an electric motor and a gasket which can prevent a foreign matter from getting inside the electric motor even if there is a recess between the surfaces sandwiching the gasket.

An electric motor according to the present disclosure includes: a first member having a recess-formed surface where a recess is formed; a gasket having a bead, the bead being placed such that the bead is in contact with a part of the recess-formed surface other than the recess; and a second member sandwiching the gasket together with the first member.

A gasket according to the present disclosure has a bead and is placed between a first member having a recess-formed surface, where a recess is formed, and a second member, in which the beads are in contact with a part of the recess-formed surface other than the recess.

A description will now be made about an electric motor and a gasket according to some embodiments of the present disclosure by referring to the accompanying drawings. The following description assigns the same reference numerals to constituent elements having the same or similar functions. Such elements may not be described redundantly.

### First Embodiment

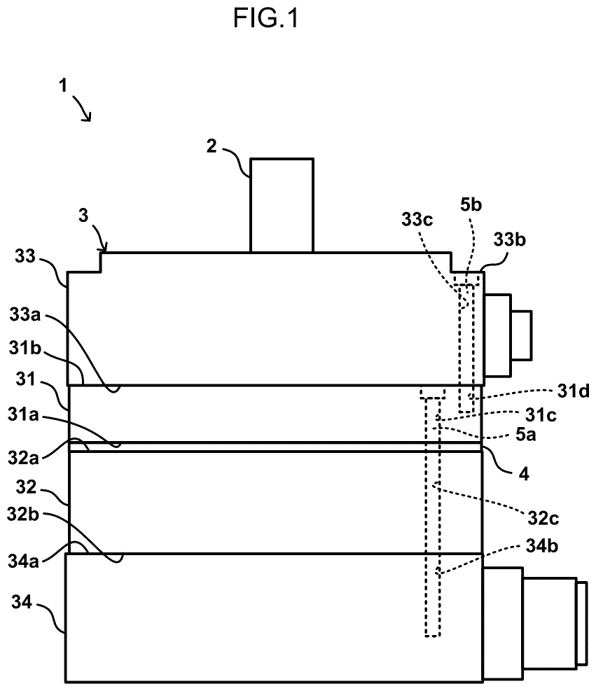

FIG. 1 is a front view of an example of an electric motor. An electric motor 1 is applied to a machine tool, for instance. The electric motor 1 includes a servo motor, a spindle motor and so on.

The electric motor 1 includes a rotator 2 and a stator 3. The rotator 2 is a member which is rotated by magnetic force exerted from the stator 3.

The stator 3 is a member which generates magnetic force for rotating the rotator 2. The stator 3 includes a first member 31, a second member 32, a gasket 4, a third member 33, and a fourth member 34.

The first member 31 is, for example, one of the members constituting a housing of the electric motor 1. The first member 31 has a surface 31a that is in contact with the gasket 4, and a surface 31b that is in contact with the third member 33. The surface 31a in contact with the gasket 4 and the surface 31b in contact with the third member 33 are flat.

There is a through hole 31c formed between the surface 31b in contact with the third member 33 and the surface 31a in contact with the gasket 4. The through hole 31c is a hole into which a first fastener 5a is inserted. The through hole 31c is formed in a position at a little distance from the side of the first member 31, for example. The through hole 31c includes a counterbored hole and a pass-through hole.

The counterbored hole is for receiving the head of the first fastener 5a. The pass-through hole is for inserting the threaded part of the first fastener 5a. The pass-through hole extends from the bottom of the counterbored hole toward the surface 31a that is in contact with the gasket 4. That is to say, the pass-through hole penetrates between the bottom of the counterbored hole and the surface 31a in contact with the gasket 4.

The surface 31b that is in contact with the third member 33 is provided with a blind hole 31d into which a second fastener 5b is inserted, about the second fastener 5b will be described later. The blind hole 31d is formed between the side of the first member 31 and the through hole 31c into which the first fastener 5a is inserted. The blind hole 31d is, for instance, a tapped hole. The tapped hole is a hole formed by tapping.

The first member 31 is produced by die-casting, by way of example. The first member 31 is, for instance, an aluminum die-cast member.

The second member 32 is, for example, a core of the stator 3. For example, the second member 32 consists of a plurality of magnetic steel sheets stacked on top of one another.

The second member 32 has a surface 32a that is in contact with the gasket 4, and a surface 32b which is in contact with the fourth member 34. The surface 32a in contact with the gasket 4 and the surface 32b in contact with the fourth member 34 are flat.

There is a through hole 32c formed between the surface 32a in contact with the gasket 4 and the surface 32b in contact with the fourth member 34. The through hole 32c is a hole into which the first fastener 5a is inserted. For example, the through hole 32c is a pass-through hole. In a case where the second member 32 consists of the magnetic steel sheets, the through hole 32c is formed by stamping each of the steel sheets before stacking them.

The gasket 4 is a member configured to enhance airtightness and liquid-tightness between the first member 31 and the second member 32. More specifically, the gasket 4 is configured to prevent a foreign matter, such as cutting fluid, from getting inside the electric motor 1 between the first member 31 and the second member 32. The gasket 4 is a metallic member, for instance. At least one of the surfaces of the gasket 4 may be coated with rubber. That is to say, the gasket 4 may be formed by sandwiching a metallic layer by rubber layers. Alternatively, the gasket 4 may be a rubber member.

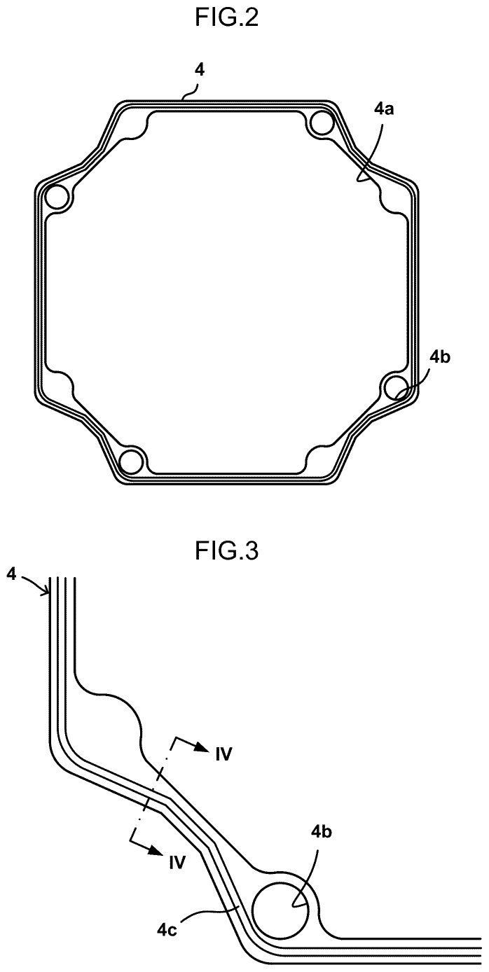

FIG. 2 is a plane view showing an example of the gasket 4. The gasket 4 has an outer shape corresponding to those of the first member 31 and the second member 32. The gasket 4 is formed in an annular shape. In other words, a through hole 4a is formed in the center of the gasket 4.

In addition to that, the gasket 4 is provided with a plurality of small-diameter through holes 4b. Each small-diameter through hole 4b is configured to put the first fastener Sa through it, or to put a positioning pin through it for positioning the first member 31 and the second member 32 to each other.

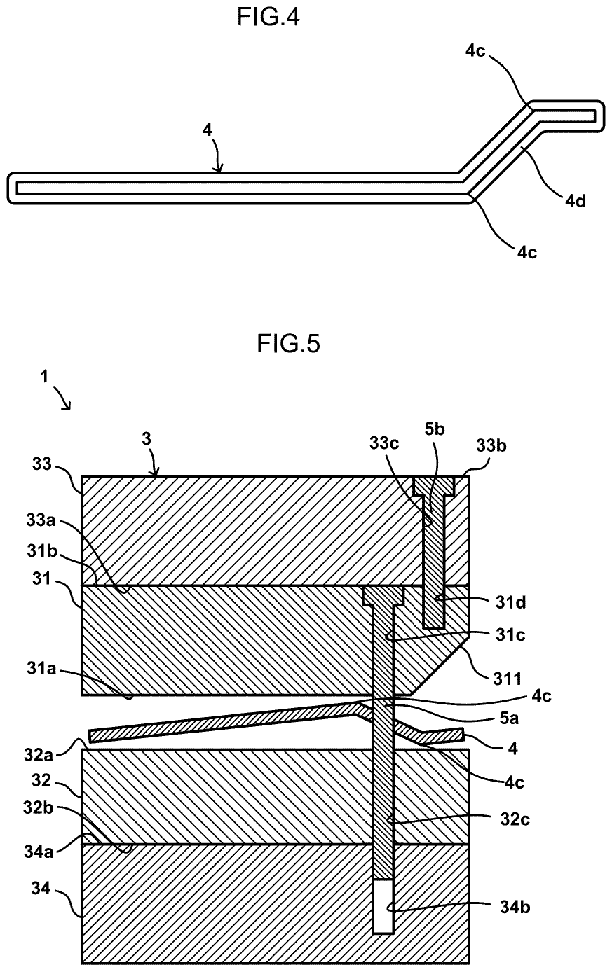

FIG. 3 is an enlarged view showing a part of FIG. 2. The gasket 4 has a bead 4c. The bead 4c is a recess formed in the gasket 4. More specifically, the bead 4c is configured to apply the maximum pressure on the first member 31 and the second member 32 when the gasket 4 is sandwiched between the first member 31 and the second member 32. The bead 4c is formed in the annular shape along the outer shape of the gasket 4.

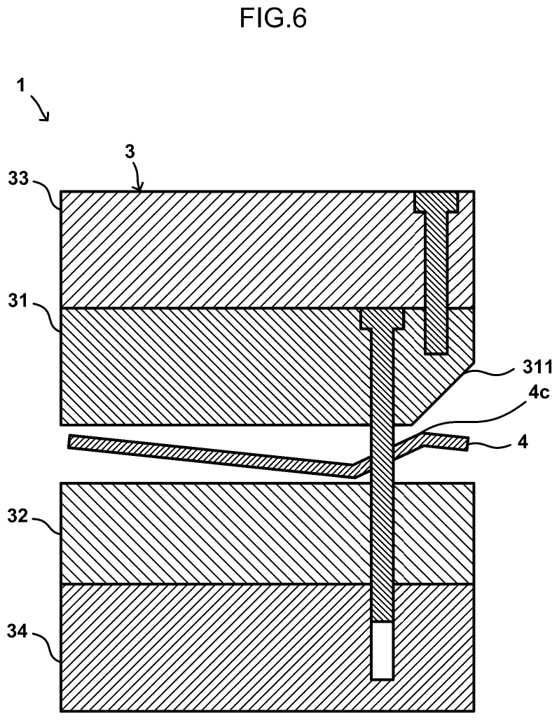

FIG. 4 is an aligned section view IV-IV of FIG. 3. The cross-section of the gasket 4 has a shape in which a plate-like member is bent at one or more positions. According to the example shown in FIG. 4, the gasket 4 has a shape in which the plate-like member is bent at two positions. The bead 4c is formed by stamping, for example. In addition, the gasket 4 has its both surfaces coated with rubber 4d. That is to say, the gasket 4 has rubber layers on both surfaces. Alternatively, only one of the surfaces of the gasket 4 may be coated with the rubber 4d. Now, the explanation is back to FIG. 1.

The third member 33 is one of the constituent members of the housing of the electric motor 1, for instance. The third member 33 has a surface 33a which is in contact with the first member 31. The third member 33 also has a surface 33b which is located on the opposite side of the surface 33a that is in contact with the first member 31. The surface 33a which is in contact with the first member 31 is flat. Furthermore, the surface 33b located on the opposite side of the surface 33a in contact with the first member 31 may be flat.

Between the surface 33a in contact with the first member 31 and the surface 33b located on the opposite side of the surface 33a in contact with the first member 31, a through hole 33c is formed. Into the through hole 33c, the second fastener 5b is inserted. The through hole 33c is formed near a side surface of the third member 33. That is to say, the second fastener 5b is placed near the side of the third member 33. The third member 33 is fixed to the first member 31 by the second fastener 5b.

The through hole 33c includes a counterbored hole and a pass-through hole. The counterbored hole is for receiving the head of the second fastener 5b. The pass-through hole is for inserting the threaded part of the second fastener 5b. The pass-through hole extends from the bottom of the counterbored hole toward the surface 33a that is in contact with the first member 31. That is to say, the pass-through hole penetrates between the bottom of the counterbored hole and the surface 33a in contact with the first member 31.

The third member 33 consists of a ferrous casting, for example. The material that constitutes the third member 33 has longitudinal elastic modulus greater than that of the material constituting the first member 31. In other words, the longitudinal elastic modulus of the material constituting the first member 31 is smaller than that of the material constituting the third member 33. The third member 33 may have higher stiffness than that of the first member 31. The longitudinal elastic modulus is also called Young's modulus.

The fourth member 34 is, for example, one of the constituent members of the housing of the electric motor 1. The fourth member 34 has a surface 34a that is in contact with the second member 32. The surface 34a in contact with the second member 32 is flat.

The surface 34a that is in contact with the second member 32 is provided with a blind hole 34b into which a first fastener 5a is inserted. The blind hole 34b is, for instance, a tapped hole.

The fourth member 34 is produced by die-casting, by way of example. The fourth member 34 is, for instance, an aluminum die-cast member.

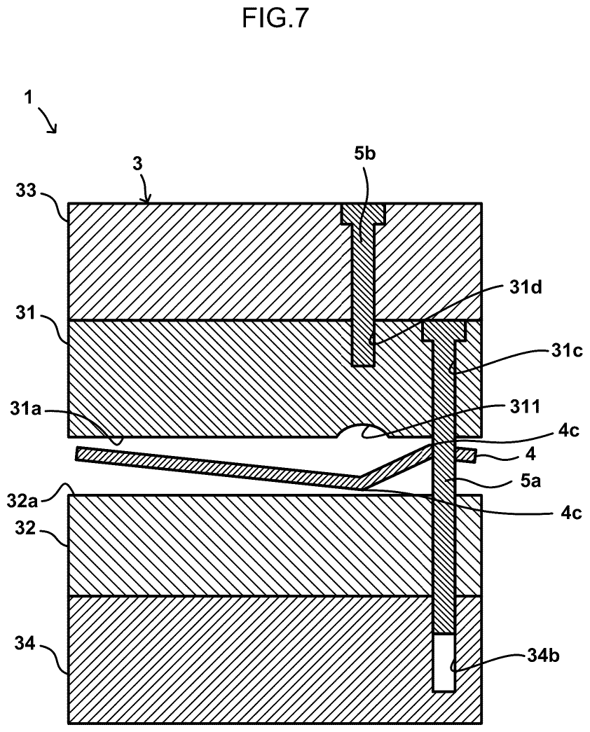

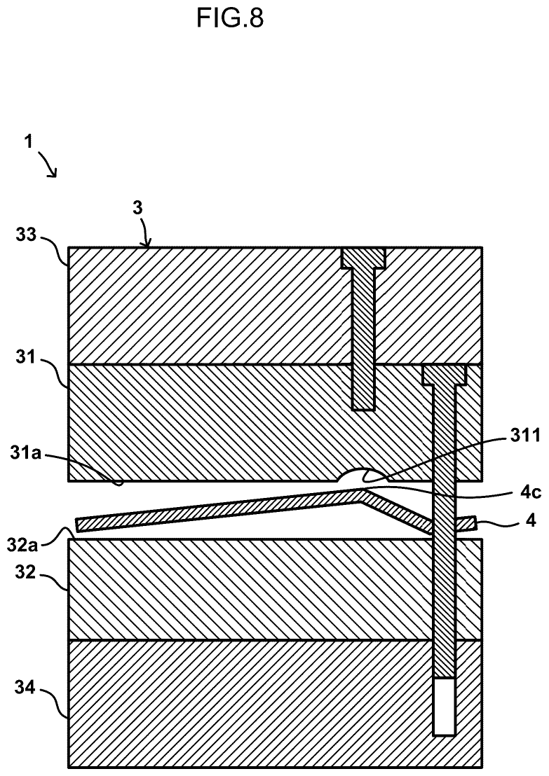

FIG. 5 illustrates an example of placement of the recess and the beads 4c. The gasket 4 shown in FIG. 5 is the gasket 4 in the aligned section view IV-IV of FIG. 3. More specifically, FIG. 5 shows the outside of the electric motor 1 on its right and the inside of the electric motor 1 on its left. FIGS. 6 to 11, about which will be described later, also show the outside of the electric motor 1 on the right and the inside of the electric motor 1 on the left.

The first fastener 5a is inserted into the through hole 31c in the first member 31, passed through the through hole 4b in the gasket 4 and the through hole 32c in the second member 32, and inserted into the blind hole 34b. That is to say, the first member 31 and the fourth member 34 are fixed to each other with the first fastener 5a. In addition to that, the gasket 4 is disposed between the first member 31 and the second member 32. More specifically, the second member 32 sandwiches the gasket 4 together with the first member 31.

When the first fastener 5a is inserted and fastened in the blind hole 34b in the fourth member 34, compressive stress is exerted on the first member 31. In other words, the first member 31 is subjected to compressing force from the bearing surface of the first fastener 5a and the second member 32.

When the second fastener 5b is inserted into the through hole 33c in the third member 33 and further into the blind hole 31d in the first member 31 to be fastened therein, the compressive stress is exerted on the third member 33. In other words, the third member 33 is subjected to compressing force from the bearing surface of the second fastener 5b and the first member 31.

Furthermore, when the second fastener 5b is inserted and fastened in the blind hole 31d in the first member 31, the first member 31 is pulled by the second fastener 5b. According to the example shown in FIG. 5, when the second fastener 5b is inserted and fastened in the blind hole 31d in the first member 31, the first member 31 is pulled upward. When the first member 31, particularly the peripheral part of the blind hole 31d is pulled by the second fastener 5b, the first member 31 is distorted.

More specifically, when the second fastener 5b pulls the first member 31, particularly the peripheral part of the blind hole 31d, a recess 311 is formed on the surface 31a that is in contact with the gasket 4. The surface 31a that is in contact with the gasket 4 of the first member 31 will be hereinafter referred to as recess-formed surface. The recess 311 is formed on the periphery of a part of the recess-formed surface 31a that intersects with the center axis of the second fastener 5b.

In a case where the blind hole 31d, into which the second fastener 5b is inserted, is formed in a position adjacent to the side of the first member 31, the recess 311 is formed in a position adjacent to the side of the recess-formed surface 31a.

The beads 4c of the gasket 4 are formed to be in contact with a part of the recess-formed surface 31a other than the recess 311. In other words, the gasket 4 is placed such that the beads 4c are in contact with a part of the recess-formed surface 31a other than the recess 311.

In the example shown in FIG. 5, one of two beads 4c formed on the gasket 4 is placed to be in contact with a flat surface other than the part where the recess 311 is formed on the recess-formed surface 31a. Furthermore, the other bead 4c of the two beads 4c formed on the gasket 4 is placed to be in contact with a flat surface of the second member 32.

Consequently, the beads 4c are elastically deformed by the force exerted by the first member 31 and the second member 32. In other words, the gasket 4 applies elastic force to the first member 31 and the second member 32, thereby preventing the formation of a gap between the first member 31 and the second member 32. The gasket 4 may have a part that undergoes plastic deformation when the first fastener 5a is fastened so as to sandwich the gasket 4 between the first member 31 and the second member 32.

In the state in which the first fastener 5a and the second fastener 5b are fastened in the blind hole 34b in the fourth member 34 and the blind hole 31d in the first member 31, respectively, the parts of the gasket 4 other than the beads 4c may also be in contact with the first member 31 and the second member 32.

FIG. 6 shows a comparative example of the electric motor 1 according to the first embodiment. As shown in the comparative example, when the bead 4c is located in a position corresponding to the recess 311, a part of the bead 4c enters the recess 311. That is to say, the bead 4c does not come into contact with the recess-formed surface 31a. It results in the formation of a gap between the first member 31 and the second member 32. Even if the gap is not formed, it is not possible to ensure sufficient airtightness and liquid-tightness between the first member 31 and the second member 32.

In the above-described embodiment, since the second fastener 5b placed near the sides of the first member 31 and the third member 33 pulls the first member 31, the recess 311 is formed near the side of the first member 31. However, the recess 311 may be formed in a position closer to the center of the first member 31, not only near the sides.

FIG. 7 illustrates another example of the placement of the recess 311 and the gasket 4. The first member 31 and the fourth member 34 are fastened to each other by the first fastener 5a.

The through hole 31c, into which the first fastener 5a is inserted, is formed in a position adjacent to the side of the first member 31, for instance. In addition, the blind hole 31d, into which the second fastener 5b is inserted, is formed in a position further away from the side than the hole into which the first fastener 5a is inserted. In other words, the through hole 31c, into which the first fastener 5a is inserted, is formed between the blind hole 31d, into which the second fastener 5b is inserted, and the side.

When the first fastener 5a is inserted and fastened in the blind hole 34b in the fourth member 34, the compressive stress is exerted on the first member 31. In other words, the first member 31 is subjected to compressing force from the bearing surface of the first fastener 5a and the second member 32.

When the second fastener 5b is inserted and fastened in the blind hole 31d in the first member 31, the first member 31 is pulled by the second fastener 5b. According to the example shown in FIG. 7, when the second fastener 5b is fastened in the blind hole 31d in the first member 31, the first member 31 is pulled upward.

When the second fastener 5b pulls the first member 31, particularly the peripheral part of the blind hole 31d, the first member 31 is deformed. More specifically, when the second fastener 5b pulls the first member 31, particularly the periphery of the blind hole 31d, the recess 311 is formed on the recess-formed surface 31a. The recess 311 is formed on a part of the recess-formed surface 31a that intersects with the center axis of the second fastener 5b.

In a case where the blind hole 31d, into which the second fastener 5b is inserted, is formed in a position at a little distance from the side of the first member 31, the recess 311 is formed in a position at a little distance from the side of the recess-formed surface 31a.

The beads 4c of the gasket 4 are formed to be in contact with a part of the recess-formed surface 31a other than the recess 311. That is to say, the gasket 4 is placed such that the beads 4c are in contact with a part of the recess-formed surface 31a other than the recess 311.

In the example shown in FIG. 7, one of the two beads 4c formed in the gasket 4 is placed to be in contact with a flat surface of the recess-formed surface 31a other than the part where the recess 311 is formed. Furthermore, the other one of the two beads 4c formed in the gasket 4 is placed to be in contact with a flat surface of the second member 32.

Consequently, the beads 4c are elastically deformed by the force exerted by the first member 31 and the second member 32. In other words, the gasket 4 applies elastic force to the first member 31 and the second member 32, thereby preventing the formation of a gap between the first member 31 and the second member 32.

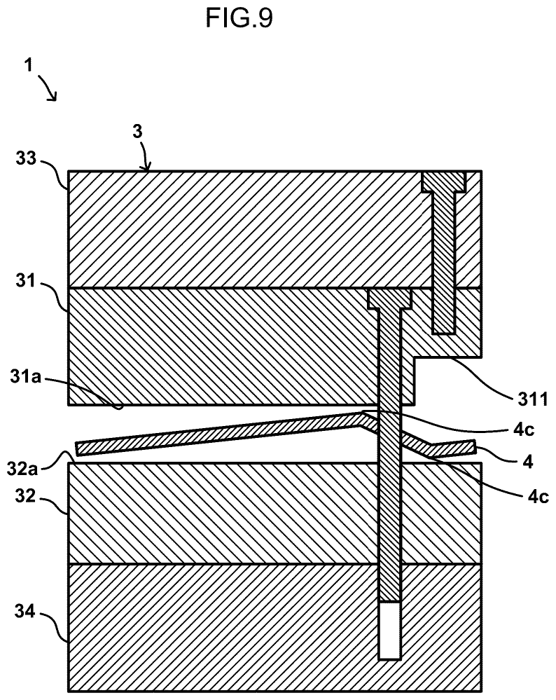

FIG. 8 shows a comparative example. As shown in the comparative example, when the bead 4c is formed in a position corresponding to the recess 311, a part of the bead 4c enters the recess 311. That is to say, the bead 4c does not come into contact with the recess-formed surface 31a. It results in the formation of a gap between the first member 31 and the second member 32. Even if the gap is not formed, it is not possible to ensure sufficient airtightness and liquid-tightness between the first member 31 and the second member 32.

### Second Embodiment

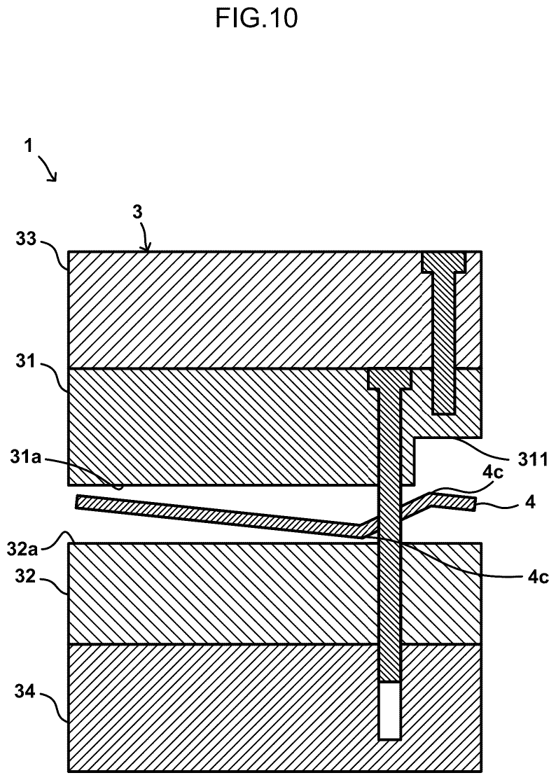

FIG. 9 illustrates the electric motor 1 according to a second embodiment. The electric motor 1 of the second embodiment is different from the electric motor 1 of the first embodiment in terms of whether the recess 311 is formed by deformation. In the electric motor 1 according to the second embodiment, the recess 311 formed on the recess-formed surface 31a of the first member 31 is not formed by the pull of the fastener. The formation of the recess 311 is caused by a machining error, for instance.

The beads 4c of the gasket 4 are formed to be in contact with a part of the recess-formed surface 31a other than the recess 311. That is to say, the gasket 4 is placed such that the beads 4c come into contact with a part of the recess-formed surface 31a other than the recess 311.

In the example shown in FIG. 9, one of the two beads 4c formed in the gasket 4 is placed to be in contact with a flat surface of the recess-formed surface 31a other than the part where the recess 311 is formed. Furthermore, the other one of the two beads 4c formed in the gasket 4 is placed to be in contact with a flat surface of the second member 32.

Consequently, the beads 4c are elastically deformed by the force exerted by the first member 31 and the second member 32. In other words, the gasket 4 applies elastic force to the first member 31 and the second member 32, thereby preventing the formation of a gap between the first member 31 and the second member 32.

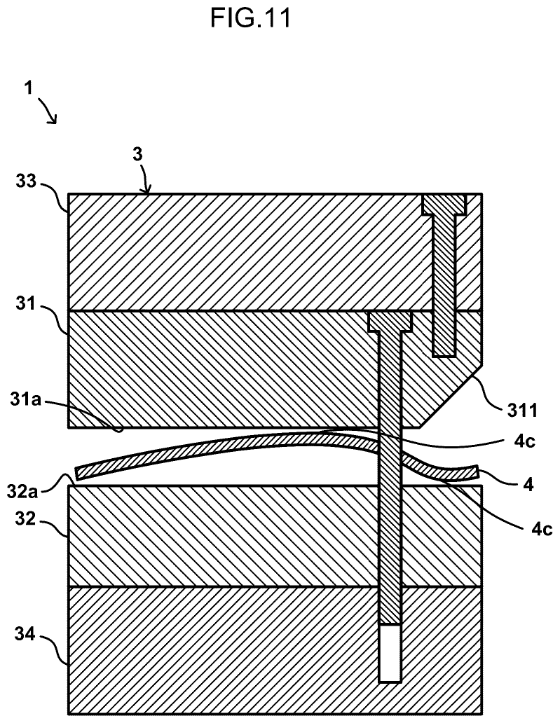

FIG. 10 shows a comparative example of the electric motor 1 according to the second embodiment. As shown in the comparative example, when the bead 4c is formed in a position corresponding to the recess 311, a part of the bead 4c enters the recess 311. That is to say, the bead 4c does not come into contact with the recess-formed surface 31a. It results in the formation of a gap between the first member 31 and the second member 32. Even if the gap is not formed, it is not possible to ensure sufficient airtightness and liquid-tightness between the first member 31 and the second member 32.

The cross-section of the gasket 4 in the above-described embodiment has a shape that a plate-like member is bent atone or more positions. However, the cross-section shape of the gasket 4 is not limited thereto.

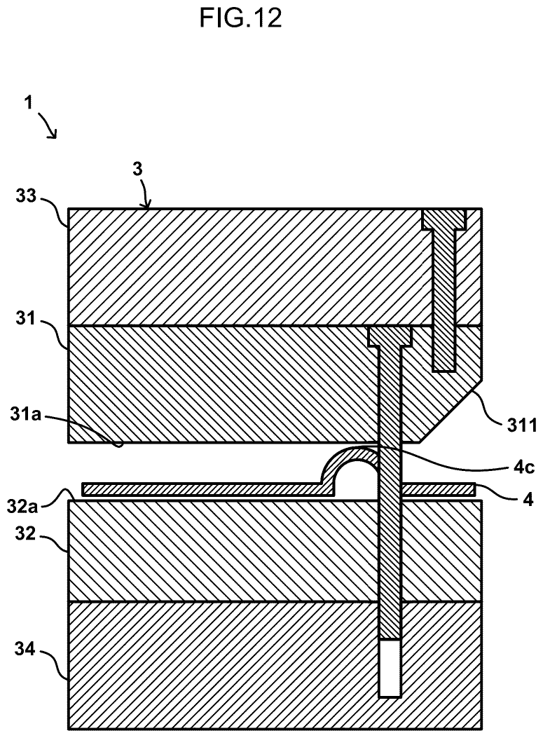

FIG. 11 shows another example of the gasket 4. The gasket 4 has a cross-section with a shape that a straight line is connected to an arc. The beads 4c are formed in the shape of an arc.

FIG. 12 shows yet another example of the gasket 4. The gasket 4 has a cross-section with a shape that a straight line is connected to a U-shaped line. The beads 4c are formed in a U-shape.

In the above-described embodiment, the first fastener 5a inserted from the through hole 31c in the first member 31 is fastened in the blind hole 34b formed in the fourth member 34. Consequently, the first member 31 and the fourth member 34 are fixed with the gasket 4 and the second member 32 in between. However, the manner of securing the first member 31 and the fourth member 34 is not limited thereto.

For example, the first fastener 5a, a third fastener and a rod may be used to secure the first member 31 and the fourth member 34.

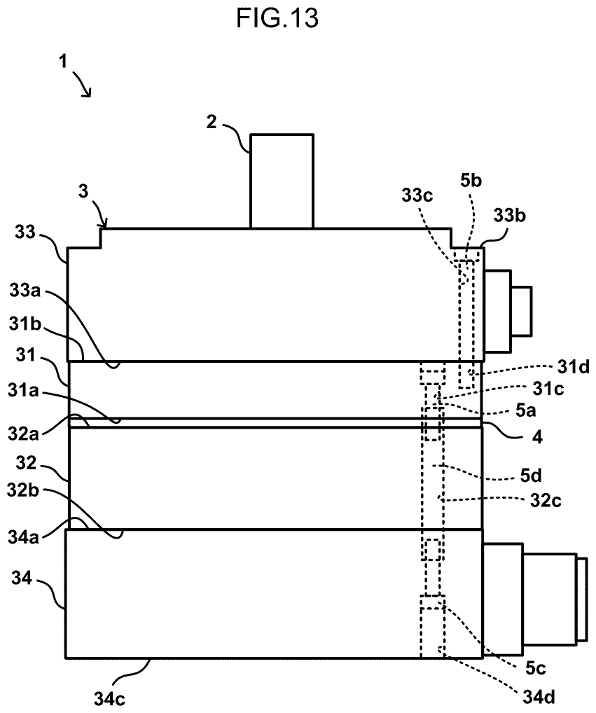

FIG. 13 shows an example of the manner of securing the first member 31 and the fourth member 34. The first member 31 is provided with the through hole 31c between the surface 31b that is in contact with the third member 33 and the surface 31a that is in contact with the gasket 4. The through hole 31c is a hole into which the first fastener 5a and a part of a rod 5d are inserted, about the rod 5d will be described later. The through hole 31c includes a counterbored hole, a rod-insertion hole, and a pass-through hole.

The counterbored hole is for receiving the head of the first fastener 5a. The rod-insertion hole is for inserting a part of the rod 5d. The rod-insertion hole is placed opposite the counterbored hole. The pass-through hole is for inserting the threaded part of the first fastener 5a. The pass-through hole extends from the bottom of the counterbored hole toward the rod-insertion hole. That is to say, the pass-through hole penetrates between the bottom of the counterbored hole and the bottom of the rod-insertion hole.

The second member 32 is provided with the through hole 32c between the surface 32a that is in contact with the gasket 4 and the surface 32b that is in contact with the fourth member 34. The through hole 32c is a hole into which the rod 5d is inserted. The through hole 32c is, for example, a pass-through hole.

The fourth member 34 has a surface 34c opposite to the surface 34a which is in contact with the second member 32, opposite to the surface 34a which is in contact with the second member 32. Between the surface 34a in contact with the second member 32 and the surface 34c opposite to the surface 34a in contact with the second member 32, a through hole 34d is formed. The through hole 34d is a hole into which a third fastener 5c and a part of the rod 5d are inserted. The through hole 34d includes a counterbored hole, a rod-insertion hole and a pass-through hole.

The counterbored hole is for receiving the head of the third fastener 5c. The rod-insertion hole is for inserting a part of the rod 5d. The rod-insertion hole is placed opposite the counterbored hole. The pass-through hole is for inserting the threaded part of the third fastener 5c. The pass-through hole extends from the bottom of the counterbored hole toward the rod-insertion hole. That is to say, the pass-through hole penetrates between the bottom of the counterbored hole and the bottom of the rod-insertion hole.

Into the through hole 32c of the second member 32, the rod 5d, which is elongated, is inserted. The rod 5d is provided with screw holes on both ends.

The first fastener 5a is inserted into the through hole 31c of the first member 31, and fastened in one of the screw holes of the rod 5d. In addition to that, the third fastener 5c is inserted into the through hole 34d of the fourth member 34, and fastened in the other of the screw holes of the rod 5d. Thus, the first member 31 and the fourth member 34 are fixed to each other by the first fastener 5a, the third fastener 5c and the rod 5d. Furthermore, the gasket 4 is disposed between the first member 31 and the second member 32.

In the above embodiment, the descriptions have been made about the example of forming the blind hole 31d between the side of the first member 31 and the through hole 31c into which the first fastener 5a is inserted (FIG. 1) and the example of forming the through hole 31c between the blind hole 31d into which the second fastener 5b is inserted and the side of the first member 31 (FIG. 7). However, the positions at which the through hole 31c and the blind hole 31d are formed in the first member 31 are not limited thereto. For example, the through hole 31c and the blind hole 31d may be placed in the vicinity of a different side of the first member 31. Alternatively, the through hole 31c and the blind hole 31d may be placed close to each other or distant from each other.

As described above, the electric motor 1 includes: the gasket 4 that has the first member 31 having the recess-formed surface 31a, where the recess 311 is formed, the gasket 4 having the beads 4c placed to be in contact with a part of the recess-formed surface 31a other than the recess 311; and the second member 32 that sandwiches the gasket 4 together with the first member 31.

Accordingly, the electric motor 1 can prevent a foreign matter from getting inside the electric motor 1 even if there is the recess 311 on the surfaces that sandwich the gasket 4. Consequently, the electric motor 1 can avoid the occurrence of a malfunction, thereby enhancing operation rate.

The electric motor 1 further includes the third member 33 that is fixed to the first member 31 by a fastener, and the recess 311 is formed by the fastener pulling on the first member 31. It is therefore possible to prevent the foreign matter from getting inside the electric motor 1 even when the fastener causes deformation.

The material that constitutes the first member 31 have longitudinal elastic modulus smaller than that of the material that constitutes the third member 33. That is to say, the first member 31 deforms largely compared to the third member 33. Even in such a case, the electric motor 1 can prevent the foreign matter from getting inside.

In addition to that, at least one of the surfaces of the gasket 4 is coated with the rubber 4d. Thus, the electric motor 1 can prevent the foreign matter from getting inside more certainly.

Furthermore, the gasket 4 is made of metal. It means that the gasket 4 has moderate elasticity and thus ensures that no foreign matters can get inside the electric motor 1. A gasket formed by sandwiching a metal layer with rubber layers has both waterproof property and heat radiation property. In addition to that, the gasket formed by sandwiching the metal layer with the rubber layers can be processed into a desired shape. Thus, in the case where the gasket 4 is formed by sandwiching the metal layer with the rubber layers, a designer can easily design the shape of the beads 4c.

Moreover, the gasket 4 has the beads 4c and is placed between the first member 31 having the recess-formed surface 31a, where the recess 311 is formed, and the second member 32, and the beads 4c are in contact with a part of the recess-formed surface 31a other than the recess 311. Thus, the gasket 4 can prevent the foreign matter from getting inside the electric motor 1 even if the recess 311 is formed on any surface of the members sandwiching the gasket 4. Consequently, the electric motor 1 can avoid the occurrence of the malfunction, thereby enhancing the operation rate.

The present disclosure has been described in detail, but is not limited to the above-described embodiments. Thus, various additions, substitutions, modifications, partial deletions and so on may be made to these embodiments without departing from the gist of the disclosure or the spirit of the disclosure as derived from the contents described in the claims and their equivalents. Furthermore, these embodiments can be implemented by combining them.

Supplementary notes according to the embodiments of the present disclosure will be made as below.

### Supplementary Note (1)

An electric motor includes: a first member that has a recess-formed surface where a recess is formed; a gasket having a bead, the bead being placed such that the bead is in contact with a part of the recess-formed surface other than the recess; and a second member sandwiching the gasket together with the first member.

### Supplementary Note (2)

The electric motor according to Supplementary Note (1) further includes a third member fixed to the first member by a fastener, in which the recess is formed by the fastener pulling on the first member.

### Supplementary Note (3)

The electric motor according to Supplementary Note (2), in which the material constituting the first member has longitudinal elastic modulus smaller than that of the material constituting the third member.

### Supplementary Note (4)

The electric motor according to any of Supplementary Notes (1) to (3), in which at least one of the surfaces of the gasket is coated by rubber.

### Supplementary Note (5)

The electric motor according to any of Supplementary Notes (1) to (4), in which the gasket is made of metal.

### Supplementary Note (6)

A gasket has a bead and is placed between a first member having a recess-formed surface where a recess is formed and a second member, in which the beads are in contact with a part of the recess-formed surface other than the recess.

1. An electric motor, comprising:
a first member having a recess-formed surface where a recess is formed;
a gasket having a bead, the bead being placed such that the bead is in contact with a part of the recess-formed surface other than the recess; and
a second member sandwiching the gasket together with the first member.

2. The electric motor according to claim 1, further comprising a third member fixed to the first member by a fastener, wherein
the recess is formed by the fastener pulling on the first member.

3. The electric motor according to claim 2, wherein a material constituting the first member has longitudinal elastic modulus smaller than that of a material constituting the third member.

4. The electric motor according to claim 1, wherein at least one of surfaces of the gasket is coated with rubber.

5. The electric motor according to claim 1, wherein the gasket is made of metal.

6. A gasket having a bead and placed between a first member having a recess-formed surface, where a recess is formed, and a second member, wherein
the bead is in contact with a part of the recess-formed surface other than the recess.
